(19) United States
(12) Patent Application Publication
(10) Pub. No.: US 2003/0208600 A1
(43) Pub. Date: Nov. 6, 2003

(54) System and method for managing persistent connections in HTTP

(76) Inventor: Robert E. Cousins, Saratoga, CA (US)

Correspondence Address: SCHNECK & SCHNECK, P.O. BOX 2-E, SAN JOSE, CA, 95109-0005, US

(21) Appl. No.: 09/821,414

(22) Filed: Mar. 28, 2001

Related U.S. Application Data
(63) Continuation-in-part of application No. 09/535,028, filed on Mar. 24, 2000, now abandoned.

(51) Int. Cl. G06F 15/16

(52) U.S. Cl. 709/227; 709/219

(57) ABSTRACT

A system and a method for managing persistent connections in a computer network environment to reduce web page service latency. This invention employs a connection management interface (CMI) device that intermediates between a client and servers and, whenever possible, maintains a persistent connection with the client and with the server. The CMI device enables the client to see a persistent connection even where the server cannot support a persistent connection, for instance, when a reply contains dynamic content, by buffering the reply from a server and rewriting the data packet header such that a persistent connection between the CMI device and client can be maintained. The CMI device also reduces latency in processing serial requests from a client by distributing these requests to various servers or server processes.

### CROSS-REFERENCE TO RELATED APPLICATION

This application is a continuation-in-part of pending application Ser. No. 09/535,028, filed Mar. 24, 2000.

### FIELD OF THE INVENTION

The present invention relates to electronic data communications between a client and a server in a computer network environment. In particular, the invention relates to managing persistent TCP/IP connections and back-to-back web page requests from a client.

### BACKGROUND ART

Web page service latency is principally due to inefficiencies in network communication. One of these inefficiencies is that the Hypertext Transfer Protocol (HTTP), which is the set of rules for exchanging files on the Web, can require the client and server to establish a new TCP/IP connection for each interaction. Reestablishing a connection creates a good deal of processing overhead.

In wide area computer network environments, namely the Internet, clients and servers are connected to each other at vastly different speeds. Typical dial-in connections for clients transfer data at about 2-14 kB/second, while servers generally have highly optimized T1 or other direct connections to the Internet that result in data transfer rates exceeding 200 kB/second. Regardless of connection speed, however, establishing a TCP/IP socket connection between a client and a server takes time (particularly if the client is subject to a “slow” connection). Once a connection is established, however, the full bandwidth is available for data transfer between the client and server. Whether the connection needs to be reestablished after each client/server interaction depends largely on the type of connection used.

HTTP has two major types of connections: “close” and “keep-alive” (or persistent). In a close connection, the client sends an HTTP request (usually a few lines of text followed by a blank line) to which the server sends a reply (usually a few lines of text in a header, a blank line, and then some content). At the end of this transmission, the server closes the connection. The client is able to use the end of connection as an end of file (EOF) marker to terminate the content of the message, which can be very useful for content which has no obvious end marker (such as binary blobs of data).

The HTTP 1.0 specification requires servers to terminate the TCP/IP connection after each data transfer. In other words, it only supports close connections. This significantly increases the load on the servers, as each data transfer requires the re-establishment of a TCP/IP connection. This version of HTTP is inefficient because, as noted above, establishing a TCP/IP connection between a client and server creates a substantial amount of transmission overhead.

The HTTP 1.1 specification, however, allows the computers to maintain a persistent, or keep-alive, TCP/IP connection, which enables a client and server to use a TCP/IP connection for more than one data transfer event. In a keep-alive connection, the header of the request indicates that the client can accept a persistent connection while the header of the reply indicates that it is a keep-alive reply. The header indicates the actual content length of the reply. Once the server has sent the proper amount of reply data, the client is free to send another request to the server over the same connection. For instance, a user might download the front page of a web site, review the page, then select another page deeper in the site. A persistent connection would allow immediate access to the second page, without the overhead of having to establish another connection. Therefore, if a client requests an additional web page from the server, it can be delivered without the need for reestablishing the connection.

The impact these two connection types have on web page service latency is significant since connection creation is responsible for up to fifty percent of this latency. Clearly, then, reducing or eliminating the need to reestablish connections would greatly speed up web page service.

The HTTP 1.1 specification requires that all messages include a valid content-length header. This header specifies the length of the message so that the receiver can properly determine the end of the message transmission and whether the message was correctly received. The message can only contain a valid content-length header if the message is a static file where the exact size is known prior to transmission. Pages with dynamic content, which is generated “on the fly”, do not contain a content-length header since the server outputs the reply header before running the script which determines what the final length of the page.

Therefore, when the server outputs a dynamically created page, the only way to signal the end of the transmission is to close the TCP/IP connection. Many popular servers, such as Apache, cannot handle keep-alive connections in this situation. This forces a return to the inefficiencies of the HTTP 1.0 specification.

Even when a keep-alive connection can be maintained between the server and client, long server delays may result if the client sends several requests to the server. These requests are buffered by TCP and, eventually, sequentially processed. The delays are the result of the later requests being buffered while the server is still working on earlier requests thus creating a bottleneck at the server.

U.S. Pat. No. 5,852,717 discloses how to increase performance of computer systems accessing the World Wide Web on the Internet by using an agent that maintains a connection cache, proxy servers, and modifying client requests to increase performance.

U.S. Pat. No. 6,128,279 discloses how to improve performance in a network by having a plurality of network servers directly handle load balancing on a peer-to-peer basis.

U.S. Pat. No. 6,021,426 discloses a system and method for reducing latency and bandwidth requirements when transferring information over a network. The reduction in latency and bandwidth requirements is achieved by separating static and dynamic portions of a resource, caching static portions of the resource on the client and having the client, instead of the server, determine whether it requires both the static and dynamic portions of the resource.

The present invention discloses new ways to reduce web page latency, including managing persistent TCP/IP connections and disclosing a more efficient approach to handle back-to-back web page requests from a client.

An object of the present invention is to provide a method to decrease web page service latency between a client and a server during the transfer of dynamic content by enabling the client and server to maintain a persistent connection with an intermediary Connection Management Interface device.

Another object of the invention is to provide the client with the performance benefits offered by a keep-alive connection even when the server cannot support such a connection.

Another object of the invention is to maintain a keep-alive connection to the server even when the client does not request it.

Another object of the present invention is to provide minimum latency in processing when the client transmits serial HTTP requests to the server by distributing these requests to various servers or server processes.

### SUMMARY OF THE INVENTION

A Connection Management Interface (CMI) device is provided that can maintain a persistent connection to a client during the transfer of dynamically created data files between a client and server. The CMI device intermediates between a client and a server.

The client sends an HTTP request to the CMI device, which fully proxies a web server. Within the CMI device, the Client Network Interface Card (NIC) receives the request and places it in the Request Queue. The Master then takes that request from the Request Queue and matches it with the next available server connection. The server connection is maintained as a keep-alive connection whenever possible.

If the client has made several requests, the CMI device notices the stacked requests. These requests can be sent to several server processes (perhaps on several machines). Therefore, the client should see less web page service latency since this eradicates delays due to a bottleneck at the server. Requests are sent to servers in advance of the completion of the previous reply.

The CMI device fully proxies the web server. The CMI device fully buffers requests and replies and only sends them to the server/client when the length of the entire request/reply is known. The request or reply's header is reformatted to reflect the actual content length, thus enabling the CMI device to maintain persistent connections with a server or client.

The server serves the page back to the CMI's Server NIC. The Server NIC then decides whether this reply deserves special processing (such as compression, encryption, conversion; see copending application Ser. No. 09/535,028). If no processing is necessary, the Server NIC places the reply in the Reply Queue. If special processing is required, the Server NIC places the reply in the Processing Queue. The reply is processed and placed in the Reply Queue.

The Client NIC then gets the reply from the Reply Queue, formats it, and sends it to the client. The Client NIC has access to the entire reply and can specify in the reply header the complete size of the reply message. The client therefore “sees” a persistent connection with the server, even if the server is not able to maintain a persistent connection due to the dynamic content of the reply.

When a client requests dynamic content from a server, the server transmits that data to the CMI device and closes the connection to signal the end of the file. As the data file has been completely transferred, the size of the data file is now known. The CMI device reformats the data file and attaches a valid content-length header. The file now can be transferred to the client without the need to terminate the persistent connection. Therefore, the CMI device is able to maintain the persistent connection with the client. In addition, the overhead of TCP/IP connection reestablishment between the server and the CMI device will be minor as both devices are connected via a high-speed interface.

As a result, the client sees a keep-alive connection even when the server cannot maintain such a connection. This can result in a 50% to 100% increase in throughput for normal web browsing based upon TCP connection setup and knock down times over slow connections. The client suffers no performance penalty even if the server closes the connection after transferring a page with dynamic content. The CMI device is also able to maintain a keep-alive connection to the server(s) even when the client(s) don't request them.

### BRIEF DESCRIPTION OF THE DRAWINGS

FIG. 1 is a block diagram showing the connection management interface (CMI) device in a computer network in accordance with the invention.

FIG. 2a is a block diagram showing how a client and server connect to a computer network in the absence of the CMI device of FIG. 1.

FIG. 2b is a block diagram showing how the client and server are connected to the CMI device of FIG. 1.

FIG. 3 is a block diagram showing the components of the CMI device of FIG. 1.

FIG. 4a is a diagram of an approach to pipelining HTTP requests in accordance with prior art teachings.

FIG. 4b is a diagram showing an approach to pipelining HTTP requests in accordance with the present invention.

FIG. 5a is an example of a request for a webpage.

FIG. 5b is an example of a reply to a request for a webpage where the server indicates it will close the connection.

FIG. 5c is an example of a reply to a request for a webpage where the server indicates it is able to maintain a keep-alive connection.

FIG. 6 is a flow chart detailing how the CMI device of FIG. 1 handles replies containing dynamic content from a server.

FIG. 7 is an illustration of a software application layer and the steps involved in processing a reply containing dynamic content for use in the CMI device of FIG. 1.

### BEST MODE OF CARRYING OUT THE INVENTION

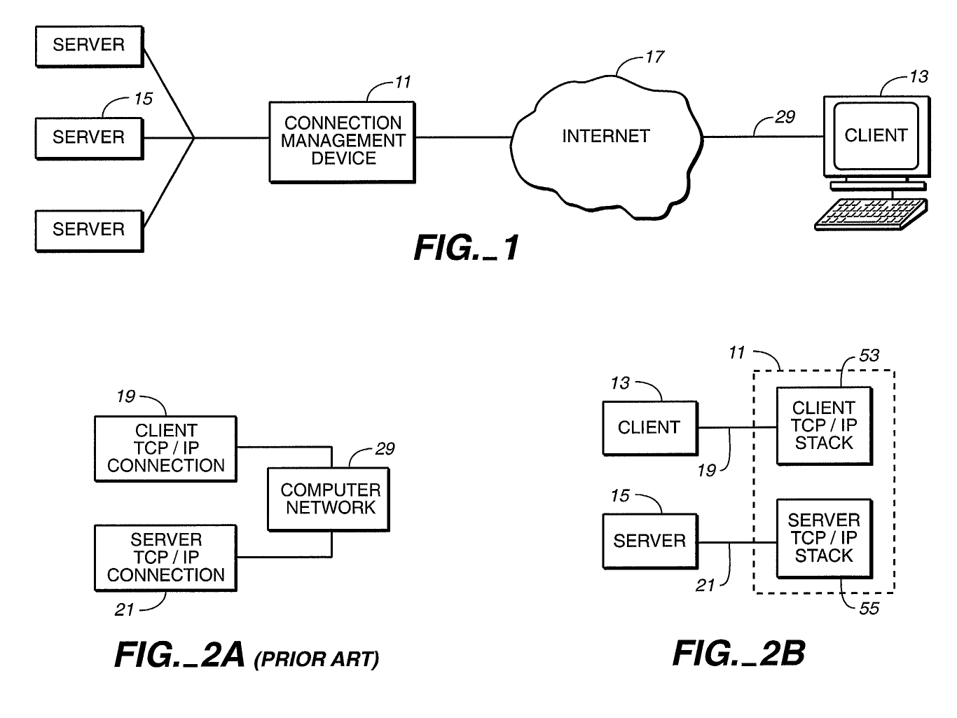

With regard to FIG. 1, the CMI device 11 intermediates between a client 13 and server 15 in a network environment. In a client and server network, clients 13 and servers 15 communicate and transfer information. The CMI device 11 is connected to a plurality of clients 13, either through a direct connection, Local Area Network (LAN), or through a Wide Area Network (WAN), such as the Internet 17. Connected on the other side of the CMI device 11 are a plurality of servers 15, either through a direct connection, LAN, or WAN. Therefore, all of the information that is transferred between a client 13 and server 15 is routed through the CMI device 11.

FIG. 2a shows how client TCP/IP connection 19 and server TCP/IP connection 21 connect a client and server to a computer network 29 in the absence of a CMI device.

As shown in FIG. 2b, COI device 11 contains a client TCP/IP stack 53 and a server TCP/IP stack 55. The client TCP/IP stack 53 establishes a persistent TCP/IP connection 19 to the computer network 29. In this implementation, a standard Ethernet network interface card and standard Ethernet cabling can make the client TCP/IP connection 19. The server TCP/IP stack 55 establishes a TCP/IP connection 21 to the computer network 29. As with the client TCP/IP connection 19, this connection can be made with a standard Ethernet network interface card and standard Ethernet cabling.

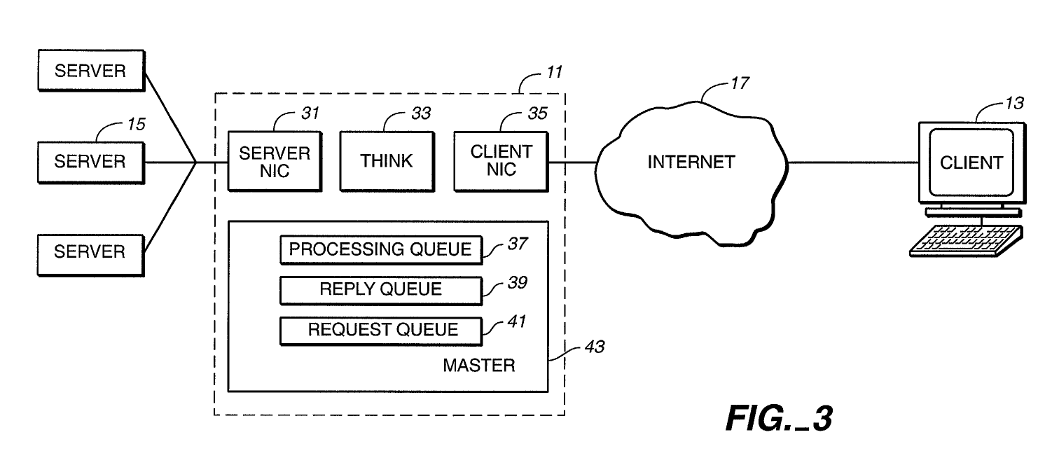

With regard to FIG. 3, the client 13 sends a request which is received by the CMI device 11. The Think Module 33, the CMI device's software application layer, consists of code and two TCP/IP stacks and is responsible for determining what sort of connection the client 13 wants and then setting up and maintaining connections with the client 13 and server 15; the Think Module also is responsible for special processing (e.g. compression) of replies (see copending application Ser. No. 09/535,028). The request first goes to the Client NIC 35 which places the request in the Request Queue 41, a buffer. The Master 43, a processor with associated code which manages the CMI device's 11 queues, or buffers, and jobs, then takes the request from the Request Queue 41 and matches it with the next available server connection via the Think Module 33, the server TCP/IP stack 55, and the Server NIC 31.

When the server 15 serves the page back to the CMI device 11, it resides in the Server NIC 31. The Server NIC 31 determines whether the reply deserves special processing, such as compression. (See copending patent application Ser. No. 09/535,028.) If special processing is required, the Server NIC 31 places the reply in the Processing Queue, a buffer, 37. The Think Module 33 processes the reply and then places it in the Reply Queue, or buffer, 39. If no special processing is required, the Server NIC 31 places the reply in the Reply Queue 39. The reply is then sent to the client 13.

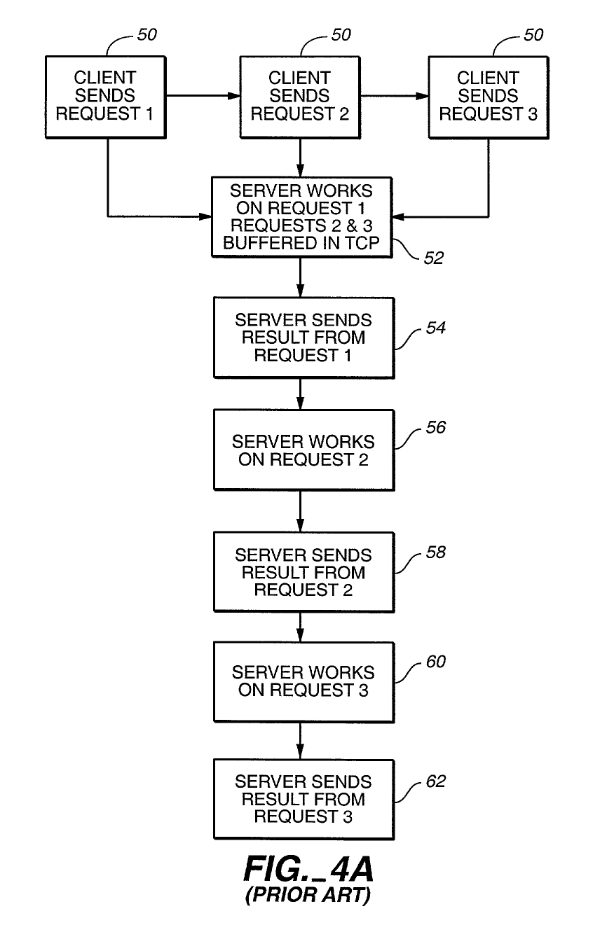

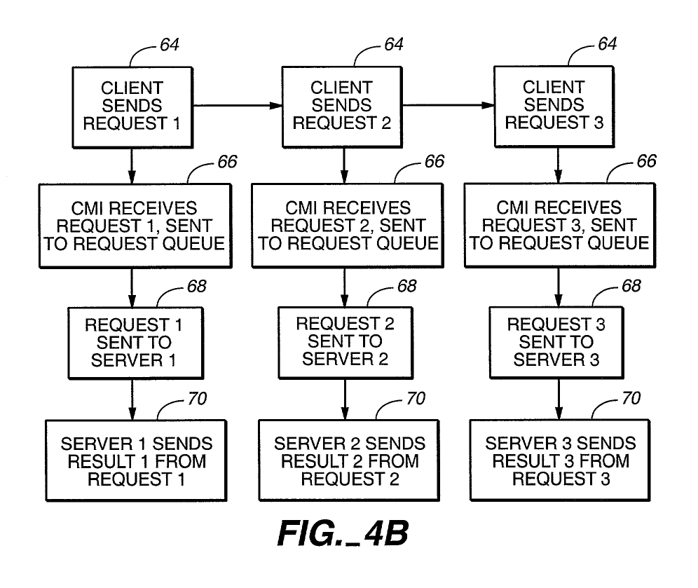

FIG. 4a shows the prior art's approach to pipelining HTTP requests, i.e., transferring requests in a back-to-back fashion to the same server or server process over the same connection. Step 52 shows that as the server begins to work on the first request, the other two requests are buffered in the TCP layer. Thus, there may be delays as the server attempts to process these multiple requests.

FIG. 4b demonstrates the invention's approach to pipelining HTTP requests and reducing latency when multiple requests are made over the same connection. Step 64 shows that when using a keep-alive connection, the client can send several requests over the same connection. As depicted in step 66, the master 43 can notice stacked requests in the request queue 41. Steps 68 and 70 show these requests are sent to several servers 15 or server processes, with the result that the client will see much less latency 68. In fact, any delays will be due to the reply channel. Compression delay on the reply only delays the first bytes of the stream since the final bytes of the compressed stream arrive sooner than the final bytes of the non-compressed equivalent stream. Using this approach, any compression delay is hidden during the transfer of the reply to the first request, unless the reply is extremely short. The COI sends the replies back to the client in the order they were requested.

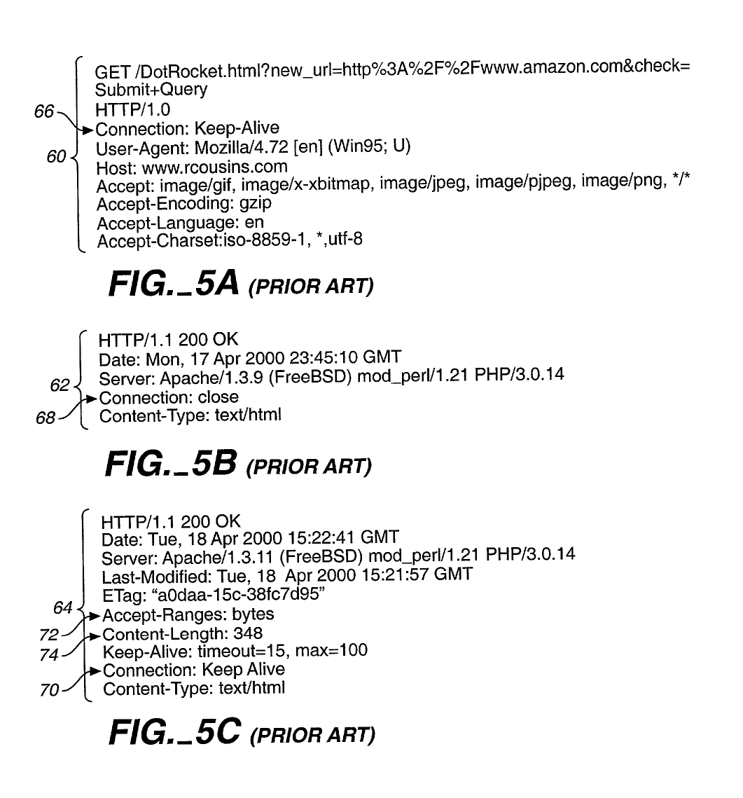

FIG. 5a shows a request 60 for a webpage. Line 66 indicates the client is willing and able to use keep-alive connections.

FIG. 5b shows a possible reply header 62 of a reply to a request for a webpage. Here, line 68 shows the server will close the connection rather than maintain the keep-alive connection.

FIG. 5c shows a reply header where the server indicates it is able to maintain a keep-alive connection. Lines 72 and 74 provide information indicating the content length of the reply. However, web servers are not always able to provide this information when replies include dynamic content. Dynamic content is created “on the fly” and is the result of server-side includes, CGI scripts, PHP, Perl scripts, or other executables.

The CMI device provides a solution to this problem. Since the CMI device can buffer the entire reply from the server, it can calculate the length of the reply when the server is not able to do so. A new reply header is written, indicating the length of the reply.

The CMI device is therefore able to let the client see a keep-alive connection even if the server is not able to maintain such a connection because the keep-alive connection between the CMI device and client is maintained.

Servers may not be able to maintain a keep-alive connection because of the HTTP 1.1 specification's requirement that all replies include a valid content-length header. When replies include dynamic content, the web server must output the reply header before running the script. Therefore, the information indicating the length of the page is missing and the connection will be shut down in order to provide the client with an End of File indication.

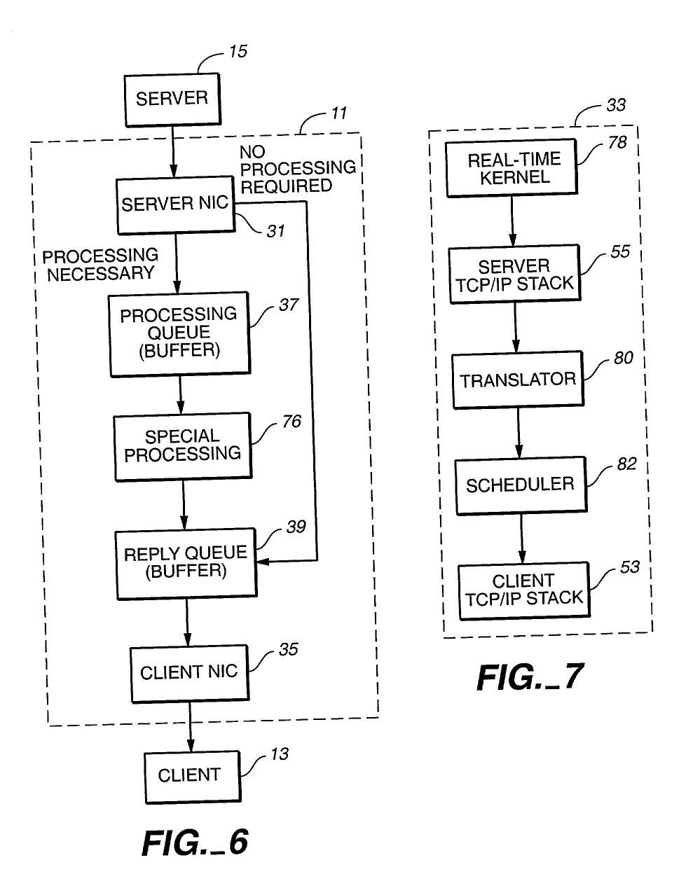

FIG. 6 is a flow chart demonstrating how the CMI device 11 handles replies containing dynamic content from a server 15. After the server 15 transmits the reply, it sheets down the connection between the server 15 and the CMI device 11 in order to provide an End of File Marker. The CMI device's 11 Server NIC 31 receives this reply. If the Server NIC 31 determines the reply deserves special processing (e.g. compression—see copending application Ser. No. 09/535,028), the reply is sent to Processing Queue 37. (If the reply does not deserve special processing, the reply is sent directly to Reply Queue 39.) The CMI device's software then performs any deserved processing tasks 76 on the reply. (For more detail about processing replies, please see copending application Ser. No. 09/535,028.) The reply is then sent to Reply Queue 39. The Client NIC 35 gets the reply from Reply Queue 39, determines the length of the reply, and rewrites the reply header to reflect the length of the reply and indicate that a keep-alive connection between the client 13 and CMI device 11 can be maintained. The Client NIC 35 then sends the reply back to client 13.

The client does not have to reestablish a TCP connection with the CMI device, which can result in a 50% to 100% increase in throughput for normal web browsing based upon TCP connection setup and knock down times over slow connections (i.e., the client's dial-in connections). The overhead of TCP/IP connection reestablishment between the server and the CMI device is minor as they are connected to each other via a high-speed interface.

With regard to FIG. 7, the real time kernel 78 provides the operating environment and manages the software, or Think Module 33, contained in the CMI device. The real time kernel can multiplex threads onto one or more processors, allowing management of multiple processes simultaneously. The real time kernel 78 also manages the allocation and reallocation of memory in the CMI device, providing such management in the stacks and threads themselves. The real time kernel also provides synchronization and mutual exclusion functions which allows threads to manage shared resources, await events, and otherwise communicate. The real time kernel 78 has additional management features that are similar to those known in the art.

The real time kernel 78 directs the incoming reply to Server TCP/IP stack 55. If the reply deserves special processing, it is forwarded to the Translator 80 where it is processed (see copending patent application Ser. No. 09/535,028). The reply is then sent to the Scheduler 82. The Scheduler 82 will establish the appropriate connection with the client and forward the reply through the Client TCP/IP stack 53 (see copending patent application Ser. No. 09/535,028). As noted above, the reply may be held in a queue in a buffer both before it is processed and before it is sent back to the client.

1. A system for optimizing HTTP sessions between a plurality of clients and a plurality of servers having:
a) a connection management interface device, said device comprising:
i) buffer means for storing replies and requests from a plurality of servers and a plurality of clients;
ii) software means for managing the connection management interface operation;
iii) memory means for storing the software means; and
iv) processor means for operating the connection management interface device; and
b) connection means for connecting the connection management interface device between a plurality of clients and a plurality of servers.

2. The system of claim 1 wherein the connection management interface device is capable of maintaining a keep-alive connection to a client even where a server has dropped its keep-alive connection with said device.

3. The system of claim 1 wherein the connection management interface device can distribute back-to-back requests over the same connection from one client to a plurality of servers or server processes.

4. The system of claim 1 wherein the connection management interface device fully proxies a web server.

5. The system of claim 1 wherein the buffer means is random access memory.

6. The system of claim 1 wherein the buffer means is flash memory.

7. The system of claim 1 wherein the buffer means is a disk memory.

8. The system of claim 1 wherein the software means includes means for managing the client TCP/IP connection.

9. The system of claim 1 wherein the software means includes means for managing the server TCP/IP connection.

10. The system of claim 1 wherein the software means includes means for rewriting the header of a reply containing dynamic content to include information about the size of said reply.

11. The system of claim 1 wherein the software means includes means for distributing back-to-back requests over the same connection from a client to a plurality of servers or server processes.

12. The system of claim 1 wherein the processor means include means for managing queues within the connection management interface device.

13. The system of claim 1 wherein the processor means include means for managing jobs within the connection management interface device.

14. A method for a connection management interface device connected between a plurality of clients and a plurality of servers in a computer network environment to enable a client to see a keep-alive connection even where the server has dropped the keep-alive connection comprising:
a) buffering a reply containing dynamic content from a server until the entire reply is received;
b) determining the length of said reply;
c) reformatting the header of said reply to include information about the length of said reply; and
d) sending said reply back to the client.

15. A method for a connection management interface device connected between a plurality of clients and a plurality of servers in a computer network environment to distribute back-to-back requests transmitted over the same connection from one client to a plurality of servers or server processes comprising:
a) receiving and buffering back-to-back requests made by a client;
b) noticing stacked requests; and
c) distributing said requests to a plurality of servers or server processes.

16. An apparatus for optimizing HTTP sessions between a plurality of clients and a plurality of servers comprising:
a) buffer means for storing replies and requests from a plurality of servers and a plurality of clients;
b) software means for managing the operation of the apparatus;
c) memory means for storing the software means;
d) processor means for operating the connection management interface device; and
e) connections means for connecting the apparatus between a plurality of clients and a plurality of servers in a computer network environment.

17. The apparatus of claim 14 wherein the buffer means is random access memory.

18. The apparatus of claim 14 wherein the buffer means is flash memory.

19. The apparatus of claim 14 wherein the buffer means is a disk memory.

20. The apparatus of claim 14 wherein the software means includes means for managing the client TCP/IP connection.

21. The apparatus of claim 14 wherein the software means includes means for managing the server TCP/IP connection.

22. The system of claim 1 wherein the processor means include means for managing queues within the connection management interface device.

23. The system of claim 1 wherein the processor means include means for managing jobs within the connection management interface device.

24. The apparatus of claim 14 wherein the connection means includes a TCP/IP connection between the apparatus and a client.

25. The apparatus of claim 14 wherein the connection means includes a TCP/IP connection between the apparatus and a server.
